(19) United States
(12) Patent Application Publication
(10) Pub. No.: US 2026/0101287 A1
(43) Pub. Date: Apr. 9, 2026

(54) POWER CONTROL FOR AI-BASED UPLINK

(71) Applicant: Telefonaktiebolaget LM Ericsson (PUBL), Stockholm (SE)

(72) Inventors: Jingya Li, GÖTEBORG (SE); Daniel Chen Larsson, LUND (SE); Roy Timo, KUNGSÄNGEN (SE); Yufei Blankenship, KILDEER, IL (US); Henrik Rydén, STOCKHOLM (SE); Mattias Frenne, UPPSALA (SE)

(21) Appl. No.: 19/115,429

(22) PCT Filed: Sep. 28, 2023
(86) PCT No.: PCT/SE2023/050955

§ 371 Date: Mar. 26, 2025

Related U.S. Application Data
(60) Provisional application No. 63/411,710, filed on Sep. 30, 2022.

(51) Int. Cl. H04W 52/14; H04W 52/28

(52) U.S. Cl. CPC H04W 52/146; H04W 52/281

(57) ABSTRACT

According to some embodiments, a method performed by a wireless device comprises obtaining a priority associated with each of one or more fields of an uplink transmission. An interpretation of the one or more fields is based on a machine learning model and is undefined with respect to an existing uplink control information (UCI) type. The method further comprises allocating a transmit power to one of the one or more fields based on the obtained priority and transmitting the uplink transmission based on the allocated transmit power.

### TECHNICAL FIELD

The present disclosure generally relates to communication networks, and more specifically to power control for artificial intelligence (AI)/machine learning (ML)-based uplink.

### BACKGROUND

Artificial Intelligence (AI) and Machine Learning (ML) are promising tools to optimize the design of the air-interface in wireless communication networks. Example use cases include using autoencoders for channel state information (CSI) compression to reduce the feedback overhead and improve channel prediction accuracy: using deep neural networks for classifying line-of-sight (LOS) and non-LOS (NLOS) conditions to enhance the positioning accuracy: using reinforcement learning for beam selection at the network side and/or the user equipment (UE) side to reduce the signaling overhead and beam alignment latency; and using deep reinforcement learning to learn an optimal precoding policy for complex multiple input multiple output (MIMO) precoding problems.

Third Generation Partnership Project (3GPP) New Radio (NR) standardization work includes a release 18 study item on AI/ML for the NR air interface. The study item will explore the benefits of augmenting the air-interface with features enabling improved support of AI/ML based algorithms for enhanced performance and/or reduced complexity/overhead. Through studying a few selected use cases (CSI feedback, beam management, and positioning), the study item aims at laying the foundation for future air-interface use cases leveraging AI/ML techniques.

Building the AI model, or any machine learning model, includes several development steps where the actual training of the AI model is just one step in a training pipeline. An important part in AI development is the ML model lifecycle management. An example is illustrated in FIG. 1.

FIG. 1 is a flow diagram illustrating training and inference pipelines, and their interactions within a model lifecycle management procedure. The model lifecycle management typically consists of a training (re-training) pipeline, a deployment stage, an inference pipeline, and a drift detection stage.

The training (re-training) pipeline may include data integration, data pre-processing. model training, model evaluation, and model registration. Data ingestion refers to gathering raw (training) data from a data storage. After data ingestion, there may also be a step that controls the validity of the gathered data. Data pre-processing refers to feature engineering applied to the gathered data, e.g., it may include data normalization and possibly a data transformation required for the input data to the AI model. Model training refers to the actual model training steps as previously outlined. Model evaluation refers to benchmarking the performance to a model baseline. The iterative steps of model training and model evaluation continues until the acceptable level of performance (as previously described) is achieved. Model registration refers to registering the AI model, including any corresponding AI-metadata that provides information on how the AI model was developed, and possibly AI model evaluations performance outcomes.

The deployment stage makes the trained (or re-trained) AI model part of the inference pipeline. The inference pipeline may include data ingestion, data pre-processing, model operational, and data and model monitoring. Data ingestion refers to gathering raw (inference) data from a data storage. Data pre-processing stage is typically identical to corresponding processing that occurs in the training pipeline. Model operational refers to using the trained and deployed model in an operational mode. Data and model monitoring refers to validating that the inference data are from a distribution that aligns well with the training data, as well as monitoring model outputs for detecting any performance, or operational, drifts.

The drift detection stage informs about any drifts in the model operations.

Depending on where the AI/ML model is located/deployed, use cases of applying AI/ML on air inference over Uu can be divided into two categories.

One category is one-sided AI/ML model at the user equipment (UE) or network node (NW) only, where one-sided AI/ML model refers to a UE-sided AI/ML model or a network-sided AI/ML model that can be trained and then perform inference without dependency on another AI/ML model at the other end of the communication chain (UE or NW). An example use case of one-sided AI/ML model is UE-sided downlink spatial beam prediction use case, where an AI/ML model is deployed and operated at a UE. The UE uses the AI/ML model to predict the best downlink Tx beam out of a set A of beams based on the channel measurements of a set B of downlink Tx beams, where set B is different from Set A (e.g., Set B is a subset of set A).

Another category is two-sided AI/ML model at both the UE and NW, where two-sided AI/ML model refers to a paired AI/ML model(s) which need to be jointly trained and whose inference is performed jointly across the UE and the NW. In this category, one AI/ML model in the pair cannot be replaced by a legacy non-AI/ML based method. An example use case of two-sided AI/ML model is a CSI reporting use case where an AI model in the UE compresses DL CSI-RS-based channel estimates, the UE reports the compressed information (represented by a bit bucket) to the gNB, then, another AI model in the gNB decompresses those estimates.

When a UE transmits on multiple carriers and is limited in transmit power because the UE has reached its maximum transmit power, the UE prioritizes which channels and signals get priority. In such a case, section 7.3 in 3GPP TS 38.213 V17.2.0 applies, from which the UE applies the following priority order:
Physical random access channel (PRACH) transmission on the PCell
Physical uplink control channel (PUCCH) or physical uplink shared channel (PUSCH) transmissions with larger priority index
For PUCCH or PUSCH transmissions with same priority index:
   PUCCH transmission with hybrid automatic repeat request acknowledgement (HARQ-ACK) information, and/or scheduling request (SR), and/or link recovery request (LRR), or PUSCH transmission with HARQ-ACK information of the priority index
   PUCCH transmission with CSI or PUSCH transmission with CSI
   PUSCH transmission without HARQ-ACK information of the priority index or CSI and, for Type-2 random access procedure, PUSCH transmission on the PCell
Sounding reference signal (SRS) transmission, with aperiodic SRS having higher priority than semi-persistent and/or periodic SRS, or PRACH transmission on a serving cell other than the PCell.

As used herein, the terms “ML-model” and “AI-model”, “AI-based feature” and “ML-based feature” are interchangeable. An AI/ML model may be defined as a functionality or be part of a functionality that is deployed/implemented in a first node. This first node may receive a message from a second node indicating that the functionality is not performing correctly, e.g. prediction error is higher than a pre-defined value, error interval is not in acceptable levels, or prediction accuracy is lower than a pre-defined value. Further, an AI/ML model may be defined as a feature or part of a feature that is implemented/supported in a first node. The first node may indicate the feature version to a second node. If the ML-model is updated, the feature version may be changed by the first node.

An ML-model may correspond to a function that receives one or more inputs (e.g. measurements) and provide as output one or more prediction(s)/estimates of a certain type. In one example, an ML-model may correspond to a function receiving as input the measurement of a reference signal at time instance t0 (e.g., transmitted in beam-X) and provide as output the prediction of the reference signal in timer t0+T.

In another example, an ML-model may correspond to a function receiving as input the measurement of a reference signal X (e.g., transmitted in beam-x), such as a synchronization signal block (SSB) whose index is ‘x’, and provide as output the prediction of other reference signals transmitted in different beams, e.g. reference signal Y (e.g., transmitted in beam-x), such as an SSB whose index is ‘x’.

Another example is a ML model for aid in CSI estimation. In such a setup the ML-model is a specific ML-model within a UE and an ML-model within the network side. Jointly both ML-models provide joint network functions. The function of the ML-model at the UE is to compress a channel input and the function of the ML-model at the network side is to decompress the received output from the UE.

A similar model may be applied for positioning wherein the input may be a channel impulse in a form related to a reference point (typically a transmit point) in time. The purpose on the network side is to detect different peaks within the impulse response that reflects the multipath experienced by the radio signals arriving at the UE side. For positioning, another way is to input multiple sets of measurements into an ML network and based on that derive an estimated position of the UE.

Another ML-model is an ML-model to aid the UE in channel estimation or interference estimation for channel estimation. The channel estimation may, for example, be for the physical downlink shared channel (PDSCH) and be associated with specific set of reference signals patterns that are transmitted from the NW to the UE. The ML-model is part of the receiver chain within the UE and may not be directly visible within the reference signal pattern as such that is configured/scheduled to be used between the NW and UE. Another example of an ML-model for CSI estimation is to predict a suitable channel quality indicator (CQI), precoding matrix indicator (PMI), rank indicator (RI), CSI-RS resource indicator (CRI) or similar value into the future. The future may be a certain number of slots after the UE has performed the last measurement or targeting a specific slot in time within the future.

The network node as used herein may be one of a generic network node, gNB, base station, unit within the base station to handle at least some operations of the functionality, relay node, core network node, a core network node that handle at least some operations of the functionality, a device supporting device-to-device (D2D) communication, a location management function (LMF) or other types of location server.

There currently exist certain challenges. For example, a problem arising from the introduction of AI/ML is that the purpose of the control bits carried in the uplink from the UE to the network are not defined in 3GPP specifications. What they mean and how to interpret them is part of the implementation. This is sometimes referred to as a bit bucket because from 3GPP specification point of view, these are just a bucket of undefined bits. In some cases it requires an AI/ML decoder that is paired to the encoder that generated the bits to interpret them. This means that the procedures used in legacy specifications when it comes to prioritization can no longer be applied. More detailed scenarios follow below to further explain cases where this problem occurs.

Scenario 1: A UE UCI report from UE to network contains one or more information elements with bits for which there is no description in the 3GPP specification. For example, how to interpret the meaning of the bits is not defined in the specification (as opposed to legacy where the meaning of, e.g., PMI and CQI is defined) and a special decoder module using e.g. AI/ML decoder model is needed to convert the carried bits into useful information such as a channel estimate or PMI.

For both one-sided and two-sided AI/ML scenarios, there are use cases where a UE generates a report based on the output(s) of one or more AI/ML models deployed in the UE, and this report is transmitted from the UE to a network in a form of UCI.

In the legacy UCI handling in NR and LTE, how to interpret the UCI bits carried on physical uplink shared channel (PUSCH)/physical uplink control channel (PUCCH) is explicitly defined, e.g. PMI or rank indication. In contrast, for some AI/ML use cases, because the AI/ML output are latent space variables it is not possible to interpretate the meaning of at least part of the UCI information element or elements that is generated based on the AI/ML model output(s).

Take the above-mentioned two-sided AI/ML model for CSI reporting use case as an example, a report carrying information about compressed CSI is generated from an AI/ML model at a UE, and the report is transmitted from the UE to the NW over Uu, then, the bits contained in the report are used by the paired AI/ML model at the network to decompress CSI. Different from legacy CSI report, there can be no explicit definition of the physical meaning such as PMI or rank indication of each bit transmitted in the UE report for this AI/ML based CSI reporting use case. Only the paired AI/ML model can decode the latent space bits into something that has meaning to the scheduler in the network side.

Another type of example use case is for one-sided AI/ML model at a UE, when the AI/ML model is first trained at the network side and then transferred from the NW to the UE. In this case, the input and output of the AI/ML model that is deployed at the UE are defined/designed by the network. Thus, only the model input needs to be specified (clearly defined) in the standard. while the model output, which is to be reported from the UE to the NW, does not have to be specified/defined in the standard, because it can be interpretable by the network.

The consequence of this is that when a UE does not know how to interpretate the meaning of at least part of the report that is generated based on its AI/ML model output(s), then the UE cannot make proper priority handling for transmitting the bits carried in the report.

In general, the current standard lacks mechanisms to support a UE to transmit a report such as UCI, when how to interpret at least part of the bits contained in the report is not defined in standard specifications. These bits are simply undefined and priority rules as defined in the legacy standard cannot be applied, which is a problem.

New solutions are needed to support such UE report transmission in the uplink for AI/ML use cases.

Scenario 2: A UE UCI report contains AI/ML model parameters.

Another set of use cases considered herein is a UE transmitting a report to a network in a form of UCI, where the report contains information about AI/ML model parameters. An example use case is AI/ML model transfer from UE to NW, where an AI/ML model or part of an AI/ML model or multiple AI/ML models is/are trained/retrained at the UE side, then, at least part of the related model parameters are transferred from a UE to the NW as a type of UCI. For example, consider a two-sided AI/ML model use case, where the model architecture is aligned and fixed at the UE and NW side, only the last few layers of the paired models are trained/retrained at the UE side and then transferred from the UE to the NW.

Compared to legacy UCI types, the bits for model parameters can have different performance requirements in terms of, e.g., priority levels, latency, and reliability. In addition, it can be the cases that some model parameters are more critical than other model parameters. Thus, new solutions are needed to support differentiated treatment of the bits for AI/ML model parameters when transmitting them as UCI in the uplink.

Scenario 3: A UE UCI report contains bits that are generated based on AI/ML model output, and the bits are associated with legacy UCI type(s) (i.e., how to interpret the meaning of the bits is defined in the specification). An example use case is a UE transmitting a report to a network in a form of UCI, where the report contains bits generated based on one or more AI/ML model outputs, and the bits are associated with a legacy UCI type(s). An example is an AI/ML model at UE for CSI prediction, where the model output includes predicted CSI (e.g., predicted CQI, predicted codebook, predicted L1-RSRP) and the UE transmits the predicted CSI as a form of UCI to the network with/without legacy CSI report. Measured CSI report without prediction typically has a better accuracy compared to a measured and also predicted CSI report. In addition, if the AI/ML model for CSI prediction is not functioning properly, the UE may fall back to the legacy CSI report method, e.g., without prediction. Thus, solutions are needed to support differentiated treatment of the bits that are generated based on an AI/ML model output (e.g., predicted CSI) and the UCI bits for legacy UCI types.

The problem of how to control the transmit power from the UE for bit bucket transmission in uplink has not been addressed.

### SUMMARY

As described above, certain challenges currently exist with artificial intelligence (AI)/machine learning (ML)-based uplink. Certain aspects of the disclosure and their embodiments may provide solutions to these or other challenges. For example, particular embodiments include prioritizations for uplink transmission power reductions that account for bit bucket transmission. Specifically, the physical uplink shared channel (PUSCH) or physical uplink control channel (PUCCH) carrying bit bucket uplink control information (UCI) bits is assigned a priority order, which then determines the order that the user equipment (UE) allocates the uplink transmission power to PUSCH/PUCCH so that the total transmission power for a transmission occasion does not exceed the maximum power allowed.

According to some embodiments, a method performed by a wireless device comprises obtaining a priority associated with each of one or more fields of an uplink transmission. An interpretation of the one or more fields is based on a machine learning model and is undefined with respect to an existing UCI type (e.g., hybrid automatic repeat request (HARQ) acknowledgement (ACK), scheduling request (SR), channel state information (CSI), etc.). The method further comprises allocating a transmit power to one of the one or more fields based on the obtained priority and transmitting the uplink transmission based on the allocated transmit power.

In particular embodiments, the one or more fields comprise one or more of an output of the machine learning model, one or more machine learning model parameters associated with the machine learning model, or an existing UCI type generated by the machine learning model (e.g., Scenarios 1, 2 and 3 described above).

In particular embodiments, the priority associated with each of the one or more fields is in relation to a priority associated with one or more existing UCI types and allocating the transmit power for the one of the one or more fields is based on the priority associated with existing UCI type and the obtained priority.

In particular embodiments, a priority associated with one of the one or more fields comprises a priority higher, equal to, or lower than a priority associated with one or more existing UCI types.

In particular embodiments, obtaining the priority associated with each of one or more fields of an uplink transmission comprises one or more of obtaining pre-defined priority rules and receiving priority rules from a network node.

In particular embodiments, the one of the one or more fields comprises a CSI report generated by a machine learning model.

In particular embodiments, the one of the one or more fields comprises a machine learning model identifier.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method performed by a network node comprises determining a priority associated with each of one or more fields of an uplink transmission. An interpretation of the one or more fields is based on a machine learning model and is undefined with respect to an existing UCI type. The method further comprises receiving the uplink transmission from a wireless device, wherein a transmit power of one or more fields of the uplink transmission is based on the determined priority.

In particular embodiments, the method further comprises transmitting an indication of the determined priorities to the wireless device.

In particular embodiments, the one or more fields comprise one or more of an output of the machine learning model, one or more machine learning model parameters associated with the machine learning model, or an existing UCI type generated by the machine learning model.

In particular embodiments, the priority associated with each of the one or more fields is in relation to a priority associated with one or more existing UCI types and the transmit power for the one of the one or more fields is allocated based on a transmit power priority associated with existing UCI type and the determined priority

In particular embodiments, a priority associated with one of the one or more fields comprises a priority higher, equal to, or lower than a priority associated with one or more existing UCI types.

In particular embodiments, determining the priority associated with each of one or more fields of an uplink transmission comprises one or more of obtaining pre-defined priority rules and training a machine learning model.

In particular embodiments, the one of the one or more fields comprises a CSI report generated by a machine learning model.

In particular embodiments, the one of the one or more fields comprises a machine learning model identifier.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments enable a UE to perform prioritization for uplink transmit power control by accounting for bit bucket transmission (non-standardized bit content) in PUCCH/PUSCH.

For scenario 1, particular embodiments support differentiated handling of transmit power control for PUCCH/PUSCH carrying bit buckets. This may result in better support for applying one- and two-sided AI/ML models for the air interface design, especially for the scenarios where the UE and network nodes are across multiple different vendors. In addition, by supporting separate beta-offset configurations for the undefined bit bucket transmissions and the legacy UCI type transmissions, particular embodiments facilitate adapting the reliability and priority levels of undefined bit bucket transmission according to the requirement of the associated AI/ML model, which in turn may result in better radio resource utilization or/and better AI/ML model performance.

For scenario 2, particular embodiments facilitate differentiated handling of transmit power control for PUCCH/PUSCH carrying AI/ML model parameters. This may lead to faster and more reliable AI/ML model parameter transfer from UE to NW, and better model retaining/update/finetuning at the network side or/and the UE side.

For scenario 3, particular embodiments support differentiated handling of transmit power control for PUCCH/PUSCH carrying bits generated based on AI/ML model output (e.g., predicted CSI report) and legacy UCI bits (e.g., CSI report based on channel measurements) for a given UCI type (e.g., CSI report).

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a flow diagram illustrating training and inference pipelines, and their interactions within a model lifecycle management procedure;

FIG. 2 shows an example of a communication system, according to certain embodiments;

FIG. 3 shows a user equipment (UE), according to certain embodiments;

FIG. 4 shows a network node, according to certain embodiments;

FIG. 5 is a block diagram of a host, according to certain embodiments;

FIG. 6 is a block diagram illustrating a virtualization environment in which functions implemented by some embodiments may be virtualized;

FIG. 7 shows a communication diagram of a host communicating via a network node with a UE over a partially wireless connection in accordance with some embodiments;

FIG. 8 is a flowchart illustrating an example method in a wireless device, according to certain embodiments; and

FIG. 9 is a flowchart illustrating an example method in a network node, according to certain embodiments.

### DETAILED DESCRIPTION

As described above, certain challenges currently exist with artificial intelligence (AI)/machine learning (ML)-based uplink. Certain aspects of the disclosure and their embodiments may provide solutions to these or other challenges. For example, particular embodiments include prioritizations for uplink transmission power reductions that account for bit bucket transmission. Specifically, the physical uplink shared channel (PUSCH) or physical uplink control channel (PUCCH) carrying bit bucket uplink control information (UCI) bits is assigned a priority order, which then determines the order that the user equipment (UE) allocates the uplink transmission power to PUSCH/PUCCH so that the total transmission power for a transmission occasion does not exceed the maximum power allowed.

Particular embodiments are described more fully with reference to the accompanying drawings. Embodiments are provided by way of example to convey the scope of the subject matter to those skilled in the art.

Particular embodiments include a method for a UE to consider bit bucket transmission when performing prioritization of uplink transmission power control, where the bit bucket(s) is/are generated based on one or more AI/ML model(s) deployed at the UE. Assume a bit bucket corresponds to an information element in a report, such as a channel state information (CSI) report. For example, the bit bucket may correspond to new parameters that may be used as a ReportQuantity such as “AIMLBucket1,” “AIMLBucket2,” . . . where each of these fields have a standardized size (either fixed or variable/configurable). The UE and network needs to know the size of each “AIMLBucketX” in the UCI.

The ReportQuantity may be configured in the CSI-ReportConfig as in legacy NR.

In some cases, the meaning of at least part of the bits within a bit bucket, e.g. “AIMLBucketX,” is not defined in the standard specification, that is, the standard does not specify how to interpret these bits at the receiver. In a special case, the meaning of all the bits contained in the bit bucket “AIMLBucketX,” are not defined in the standard. In other words, the data block contents are not previously defined, while the format and transmission parameters of the data block are defined using principles according to particular embodiments described herein.

In some cases, a bit bucket, e.g. “AIMLBucketX,” is only decodable by another AI/ML model that is paired with the same AI/ML model (e.g., the paired AI/ML model at the network for the two-sided AI/ML model use cases) or by a node in the network that has trained/designed the AI/ML model (e.g., for the model sharing use cases where the model is trained by the network and transferred from the NW to the UE).

In some cases, a bit bucket contains information about AI/ML model parameters. In some cases, the bit bucket is associated with a legacy UCI type but has a different priority compared to the legacy UCI bits.

A UE maps bits that it should report on the physical layer to one or several bit buckets “AIMLBucketX.” X=1, 2, 3 . . . in the UCI. The content of the bit buckets is transmitted from the UE to the NW. One possibility is that the bits within the bit bucket(s) are generated by the UE based on the output of one or more AI/ML models at the UE, this is however not a limitation per se. In some embodiments, the bits contained in the bit buckets may be generated from an AI/ML model deployed at the UE and is only decodable by another AI/ML model that is paired with the generating AI/ML model (e.g., the paired AI/ML model at the network side for the two-sided AI/ML model use cases) or by a network who has trained/design the AI/ML model and transferred the model to the UE (e.g., for the model sharing use cases).

In some scenarios, how to interpret the meaning of the bits in “AIMLBucketX” is not known by the transmitting unit within the UE. The bits are mapped out to the bit buckets “AIMLBucketX” by forming a new type(s) of Uplink Control Information (UCI). The term bit bucket may also be expressed as logical channel, queue, list or similar naming convention.

Each of the bit buckets may have a maximum number of bits, or the bit buckets may not have a maximum number of bits. However, as described when mapping out the bits within the bit buckets to the channel, e.g. PUCCH or PUSCH, there may be a need to prioritize which bits from which bit bucket is mapped out and some of the bits may not be mapped out and transmitted and some will be mapped out and transmitted by the UE.

The different bit buckets, e.g. “AIMLBucket1” and “AIMLBucket2” in the UCI report, may contain bits of ordered priority and also higher reliability and/or priority requirements as compared to legacy UCI types. Thus, there may be separate treatment within the bit buckets and between the bit buckets and the legacy UCI.

Legacy UCI constitute, for example hybrid automatic repeat request (HARQ) acknowledgement (ACK), scheduling request (SR), and channel state information (CSI). HARQ-ACK may be HARQ-ACK. HARQ negative acknowledgement (NACK) or potentially discontinuous transmission (DTX). SR may be positive or negative SR for one combination of logical channels on medium access control (MAC) or single logical channels. CSI may be rank indicator (RI), layer indicator (LI), channel quality indicator (CQI), precoding matrix indicator PMI. CSI-RS resource indicator (CRI) and layer 1 reference signal received power (L1-RSRP). Some of the sub-parts of CSI may have subband or wideband reports, e.g. for PMI or CQI.

As an example, facilitating the AI/ML model to achieve a target performance may require a higher reliability of the bits associated with a particular bit bucket(s) as compared to bits associated with the legacy CSI report transmission, for example due to higher entropy of the model-generated data contents and due to more severe consequences of individual bit errors in the received and decoded data. If the bits in the bit bucket(s) is transmitted as UCI on PUSCH, then. a lower modulation order and/or coding rate may need to be configured for transmitting the bits in the bit bucket(s) as compared to transmitting the same size of a legacy CSI report on PUSCH.

For example, a rule may be specified where a bit bucket of lower number has higher priority than a bit bucket of higher number, i.e. “AIMLBucketX1” has higher priority than “AIMLBucketX2.”

As another example, the UCI bits, which consist of bits associated with bit bucket(s) and legacy UCI types, are configured to be transmitted on a PUCCH, and the number of the UCI bits is larger than the maximum UCI size that can be supported by the PUCCH resource, then the bit bucket(s) may be prioritized compared to some legacy UCI types, e.g., by discarding part or all the legacy CSI bits from the transmission. If the maximum UCI size is less than the maximum number of bits and if the bit buckets have different priority levels, then part or all of the bits associated with bit buckets with a lower priority may also be discarded.

As another example, the UE may be required to transmit bits associated with bit bucket(s) together with legacy CSI report as UCI on PUSCH, and the bits bit bucket(s) needs to be encoded with a lower coding rate because the bit bucket(s) it is targeting a lower block error rate (BLER) target compared to a legacy CSI report. For this case, different beta offsets may be configured for bits associated with bit bucket(s) and legacy CSI bits, so that the bits associated with the bit bucket(s) is transmitted with a lower coding rate by the UE to the NW.

In particular embodiments, a new type of UCI (denoted as bit bucket), which is different from legacy UCI types, is used to support the transmission of bits associated with one or more bit bucket(s) from UE to NW.

A UE may, as part of executing an AI/ML model or other functions that generates a report that is to be sent to the network as UCI, map the bits that are supposed to be reported to one or more bit buckets and potentially together with some of the legacy UCI types. The bits within the bit buckets are later mapped out to be transmitted together with the legacy UCI types. The mapping to the bit bucket may be logical mapping purely and bits by themselves do not need to move around in the memory, for example, of the UE to be mapped, where a bit bucket(s) is generated from an AI/ML model at the UE.

Some embodiments include transmit power configuration for the bits in one or more bit bucket(s) transmitted on PUCCH/PUSCH. In some embodiments, prioritizations for uplink transmission power reductions account for the bit bucket transmission. In some embodiments, the PUSCH or PUCCH carrying bit bucket UCI bits is assigned with a priority order, which then determines the order that the UE allocates the uplink transmission power to PUSCH/PUCCH, so that the total transmission power for a transmission occasion does not exceed the maximum power allowed.

In some embodiments, the PUSCHs or PUCCHs carrying different types of “bit buckets” are assigned with the same priority order, which then determines the order that the UE allocates the uplink transmission power to PUSCH/PUCCH. Here, different types of bit buckets are configured with different priority orders.

In one example, for single cell operation with two uplink carriers or for operation with carrier aggregation, if a total UE transmit power for PUSCH, PUCCH, physical random access channel (PRACH), or sounding reference signal (SRS) transmissions on serving cells in a frequency range in a respective transmission occasion i would exceed \hat{P}_{cmax}(i), the UE allocates power to PUSCH/PUCCH/PRACH/SRS transmissions according to the following priority order (in descending order) so that the total UE transmit power for transmissions on serving cells in the frequency range is smaller than or equal to \hat{P}_{cmax}(i) for that frequency range in every symbol of transmission occasion i. Here \hat{P}_{cmax}(i) is the linear value of maximum UE transmission power P_{cmax}(i) in transmission occasion i. The total UE transmit power in a symbol of a slot is defined as the sum of the linear values of UE transmit powers for PUSCH, PUCCH, PRACH, and SRS in the symbol of the slot.

The priority order may comprise PRACH transmission on the PCell and then PUCCH or PUSCH transmissions with larger priority index. For PUCCH or PUSCH transmissions with same priority index, the priority order may comprise: PUCCH transmission with HARQ-ACK information, and/or scheduling request (SR), and/or link recovery request (LRR), or PUSCH transmission with hybrid automatic repeat request acknowledgement (HARQ-ACK) information of the priority index: PUCCH transmission with bit bucket, or PUSCH transmission with bit bucket: PUCCH transmission with CSI or PUSCH transmission with CSI: PUSCH transmission without HARQ-ACK information of the priority index or CSI; and for Type-2 random access procedure, PUSCH transmission on the PCell.

In some embodiments, the PUSCH or PUCCH carrying a different UCI type of bit bucket is assigned with a different priority order, which then determines the order that the UE allocates the uplink transmission power to PUSCH/PUCCH. Here, different types of bit buckets are configured with different priority orders. For example “AIMLBucket1” has higher priority than the higher numbered “AIMLBucket2”.

In one example, for single cell operation with two uplink carriers or for operation with carrier aggregation, if a total UE transmit power for PUSCH or PUCCH or PRACH or SRS transmissions on serving cells in a frequency range in a respective transmission occasion i would exceed \hat{P}_{cmax}(i), the UE allocates power to PUSCH/PUCCH/PRACH/SRS transmissions according to the following priority order (in descending order) so that the total UE transmit power for transmissions on serving cells in the frequency range is smaller than or equal to \hat{P}_{cmax}(i) for that frequency range in every symbol of transmission occasion i. Here \hat{P}_{cmax}(i) is the linear value of maximum UE transmission power P_{cmax}(i) in transmission occasion i. The total UE transmit power in a symbol of a slot is defined as the sum of the linear values of UE transmit powers for PUSCH, PUCCH, PRACH, and SRS in the symbol of the slot.

The priority order may comprise PRACH transmission on the PCell followed by PUCCH or PUSCH transmissions with larger priority index. For PUCCH or PUSCH transmissions with same priority index, the priority order may comprise: PUCCH transmission with HARQ-ACK information, and/or SR, and/or LRR, or PUSCH transmission with HARQ-ACK information of the priority index: PUCCH transmission with bit bucket with higher priority (e.g., with larger priority index or lower bucket identity), or PUSCH transmission with bit bucket with higher priority (e.g., with larger priority index): PUCCH transmission with bit bucket with lower priority (e.g., with smaller priority index or higher bit bucket index), or PUSCH transmission with bit bucket with lower priority (e.g., with smaller priority index): PUCCH transmission with CSI, or PUSCH transmission with CSI: PUSCH transmission without HARQ-ACK information of the priority index or CSI; and for Type-2 random access procedure, PUSCH transmission on the PCell.

In some embodiments, the PUSCH or PUCCH carrying a bit bucket UCI type is assigned with a priority order that is the same as for a legacy UCI type, and this priority order is used for determining the order that the UE allocates the UL transmission power to PUSCH/PUCCH. This option can be used wherein the functionality that generates the bits for the bit bucket is rather similar to the functionality that legacy UCI that it has similar priority as.

In one example, for single cell operation with two uplink carriers or for operation with carrier aggregation, if a total UE transmit power for PUSCH, PUCCH, PRACH, or SRS transmissions on serving cells in a frequency range in a respective transmission occasion i would exceed \hat{P}_{cmax}(i), the UE allocates power to PUSCH/PUCCH/PRACH/SRS transmissions according to the following priority order (in descending order) so that the total UE transmit power for transmissions on serving cells in the frequency range is smaller than or equal to \hat{P}_{cmax}(i) for that frequency range in every symbol of transmission occasion i. Here \hat{P}_{cmax}(i) is the linear value of maximum UE transmission power P_{cmax}(i) in transmission occasion i. The total UE transmit power in a symbol of a slot is defined as the sum of the linear values of UE transmit powers for PUSCH, PUCCH, PRACH, and SRS in the symbol of the slot.

The priority order may comprise PRACH transmission on the PCell followed by PUCCH or PUSCH transmissions with larger priority index. For PUCCH or PUSCH transmissions with same priority index, the priority order may comprise: PUCCH transmission with HARQ-ACK information, and/or SR, and/or LRR, or PUSCH transmission with HARQ-ACK information of the priority index and/or PUCCH transmission with bit bucket with higher priority (e.g., with larger priority index), or PUSCH transmission with bit bucket with higher priority (e.g., with higher priority index): PUCCH transmission with CSI, and/or bit bucket with lower priority, or PUSCH transmission with CSI, and/or bit bucket with lower priority: PUSCH transmission without HARQ-ACK information of the priority index or CSI; and for Type-2 random access procedure, PUSCH transmission on the PCell.

In some embodiments, the PUSCH or PUCCH carrying a bit bucket UCI type is assigned with a priority order that is mixed between the same as for a legacy UCI type or not the same, and this priority order is used for determining the order that the UE allocates the UL transmission power to PUSCH/PUCCH. This option can be used wherein the functionality that generates the bits for the bit bucket is rather similar to the functionality that legacy UCI that it has similar priority as. Together with separate for the ones that that is not true for.

In one example, for single cell operation with two uplink carriers or for operation with carrier aggregation, if a total UE transmit power for PUSCH, PUCCH, PRACH, or SRS transmissions on serving cells in a frequency range in a respective transmission occasion i would exceed \hat{P}_{cmax}(i), the UE allocates power to PUSCH/PUCCH/PRACH/SRS transmissions according to the following priority order (in descending order) so that the total UE transmit power for transmissions on serving cells in the frequency range is smaller than or equal to \hat{P}_{cmax}(i) for that frequency range in every symbol of transmission occasion i. Here \hat{P}_{cmax}(i) is the linear value of maximum UE transmission power P_{cmax}(i) in transmission occasion i. The total UE transmit power in a symbol of a slot is defined as the sum of the linear values of UE transmit powers for PUSCH, PUCCH, PRACH, and SRS in the symbol of the slot.

The priority order may comprise PRACH transmission on the PCell followed by PUCCH or PUSCH transmissions with larger priority index. For PUCCH or PUSCH transmissions with same priority index, the priority order may comprise: PUCCH transmission with HARQ-ACK information, and/or SR, and/or LRR, or PUSCH transmission with HARQ-ACK information of the priority index: PUCCH transmission with bit bucket with higher priority (e.g., with higher priority index), or PUSCH transmission with bit bucket with higher priority (e.g., with higher priority index): PUCCH transmission with CSI, and/or bit bucket with lower priority, or PUSCH transmission with CSI, and/or bit bucket with lower priority: PUSCH transmission without HARQ-ACK information of the priority index or CSI; and for Type-2 random access procedure, PUSCH transmission on the PCell.

Alternatively, the priority order may comprise PRACH transmission on the PCell followed by PUCCH or PUSCH transmissions with larger priority index. For PUCCH or PUSCH transmissions with same priority index, the priority order may comprise: PUCCH transmission with HARQ-ACK information, and/or SR, and/or LRR, or PUSCH transmission with HARQ-ACK information of the priority index: PUCCH transmission with bit bucket with higher priority (e.g., with larger priority index), or PUSCH transmission with bit bucket with higher priority (e.g., with larger priority index): PUCCH transmission with CSI, or PUSCH transmission with CSI: PUCCH transmission with bit bucket with lower priority (e.g., with smaller priority index or higher bit bucket index), or PUSCH transmission with bit bucket with lower priority (e.g., with smaller priority index): PUSCH transmission without HARQ-ACK information of the priority index or CSI and, for Type-2 random access procedure, PUSCH transmission on the PCell.

In some embodiments, the PUSCH or PUCCH carrying a bit bucket UCI type is assigned with a priority order lower than for a legacy UCI type, and this priority order is used for determining the order that the UE allocates the UL transmission power to PUSCH/PUCCH. This may, for example, be used if the amounts of bits for the bit buckets are very large in volume and the number of CSI bits are few. Further it may depend on the functionality the bits from the bit bucket is coming from and the functionality may be something that is of less priority in general than CSI.

In one example, for single cell operation with two uplink carriers or for operation with carrier aggregation, if a total UE transmit power for PUSCH, PUCCH, PRACH, or SRS transmissions on serving cells in a frequency range in a respective transmission occasion i would exceed \hat{P}_{cmax}(i), the UE allocates power to PUSCH/PUCCH/PRACH/SRS transmissions according to the following priority order (in descending order) so that the total UE transmit power for transmissions on serving cells in the frequency range is smaller than or equal to \hat{P}_{cmax}(i) for that frequency range in every symbol of transmission occasion i. Here \hat{P}_{cmax}(i) is the linear value of maximum UE transmission power P_{cmax}(i) in transmission occasion i. The total UE transmit power in a symbol of a slot is defined as the sum of the linear values of UE transmit powers for PUSCH, PUCCH, PRACH, and SRS in the symbol of the slot.

The priority order may comprise PRACH transmission on the PCell followed by PUCCH or PUSCH transmissions with larger priority index. For PUCCH or PUSCH transmissions with same priority index, the priority order may comprise: PUCCH transmission with HARQ-ACK information, and/or SR, and/or LRR, or PUSCH transmission with HARQ-ACK information of the priority index: PUCCH transmission with CSI, or PUSCH transmission with CSI: PUCCH transmission with bit bucket with higher priority (e.g., with larger priority index or lower bucket identity), or PUSCH transmission with bit bucket with higher priority (e.g., with larger priority index): PUCCH transmission with bit bucket with lower priority (e.g., with smaller priority index or higher bit bucket index), or PUSCH transmission with bit bucket with lower priority (e.g., with smaller priority index): PUSCH transmission without HARQ-ACK information of the priority index or CSI′ and for Type-2 random access procedure, PUSCH transmission on the PCell.

In some embodiments, the UE is configured by the network with what the priority should be for specific bit buckets in relation to different UCI types and also between different “bit bucket.” That configuration maybe the same that is used for prioritizing how to map out the bit bucket in relation to legacy UCI types and other bit buckets. It may also be separate configuration for power control purely. The bit buckets may further be configured as a complete group or separate into sub-groups so that individual bit buckets may not be possible to prioritize. The configuration for prioritizing may be received by the UE from a gNB by, for example, an RRCReconfiguration message.

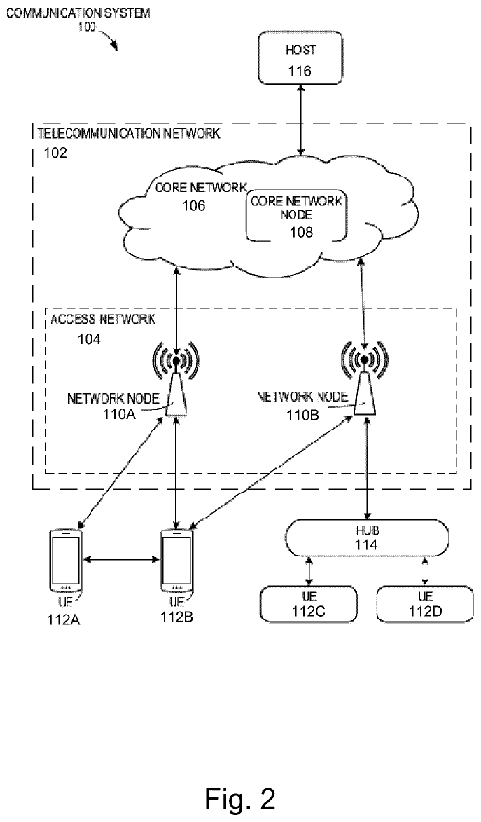

FIG. 2 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC). Mobility Management Entity (MME). Home Subscriber Server (HSS). Access and Mobility Management Function (AMF). Session Management Function (SMF). Authentication Server Function (AUSF), Subscription Identifier De-concealing function (SIDF). Unified Data Management (UDM). Security Edge Protection Proxy (SEPP). Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G. 3G. 4G. 5G standards, or any applicable future generation standard (e.g., 6G): wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth. Z-Wave. Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e, being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs. network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display. loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios. UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

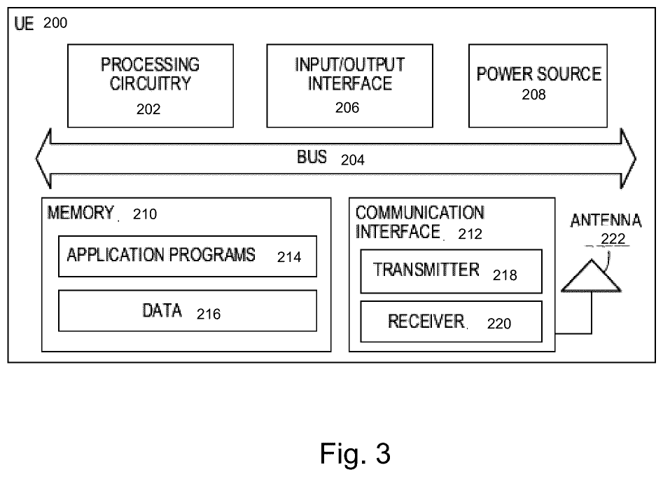

FIG. 3 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station. tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE. a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214. such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication. Wi-Fi communication, LPWAN communication, data communication, voice communication, multimedia communication, short-range communications such as Bluetooth, near-field communication, location-based communication such as the use of the global positioning system (GPS) to determine a location. another like communication function, or any combination thereof. Communications may be implemented in according to one or more communication protocols and/or standards, such as IEEE 802.11. Code Division Multiplexing Access (CDMA). Wideband Code Division Multiple Access (WCDMA). GSM. LTE. New Radio (NR). UMTS. WiMax. Ethernet, transmission control protocol/internet protocol (TCP/IP), synchronous optical networking (SONET). Asynchronous Transfer Mode (ATM), QUIC. Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

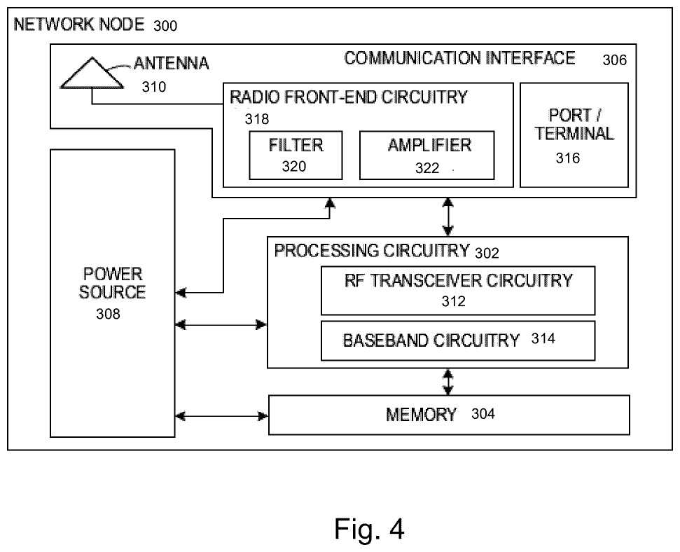

FIG. 4 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310) may be shared by different RATs). The network node 300 may also include multiple sets of the various illustrated components for different wireless technologies integrated into network node 300, for example GSM. WCDMA. LTE. NR. WiFi. Zigbee, Z-wave. LoRaWAN. Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor. application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 4 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic. maintenance, repair, and other administrative functions for the network node 300.

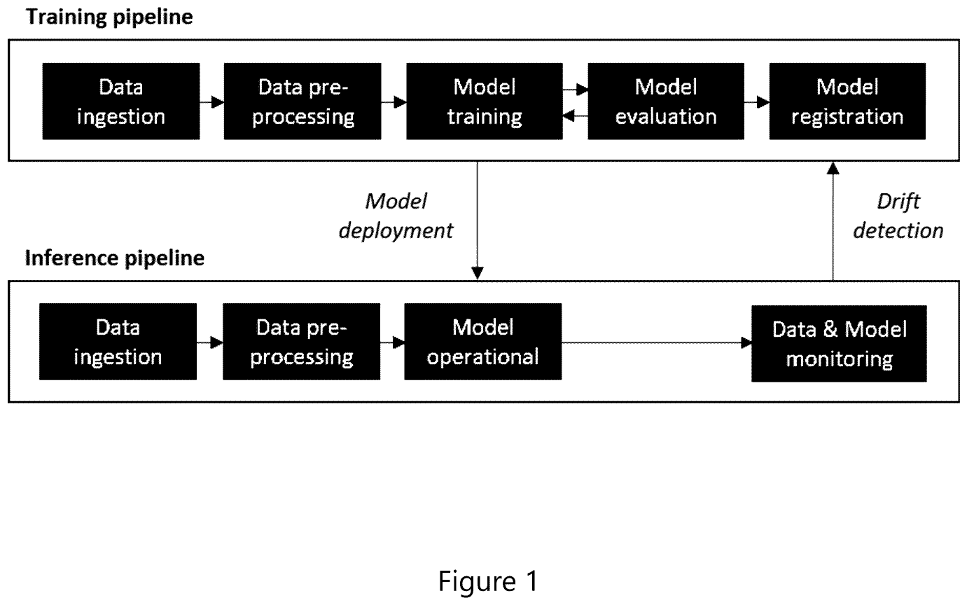

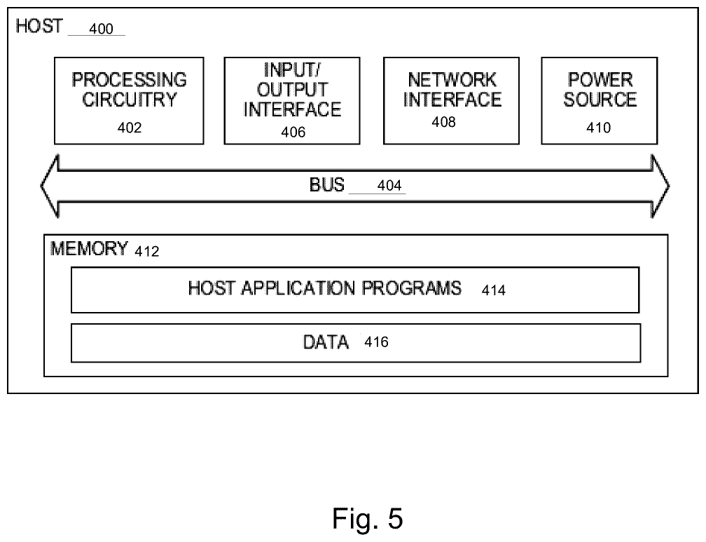

FIG. 5 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

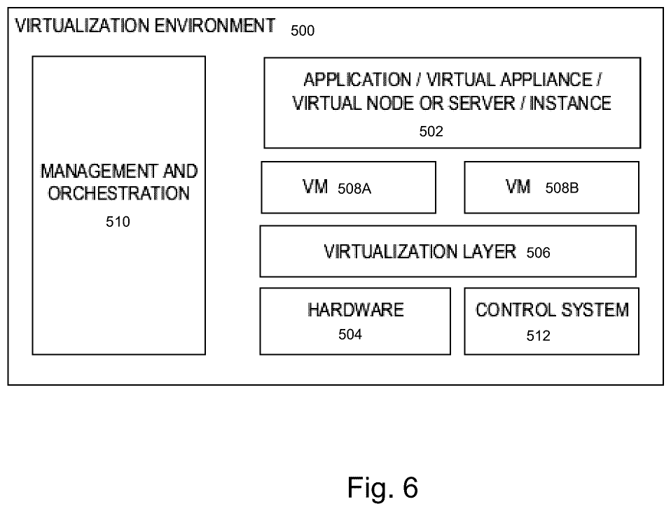

FIG. 6 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware. physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

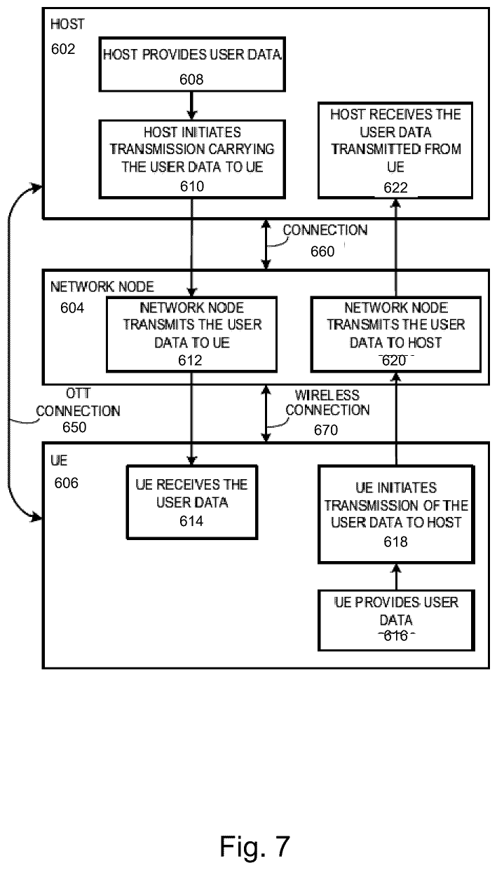

FIG. 7 shows a communication diagram of a host 602 communicating via a network node 604 with a UE 606 over a partially wireless connection in accordance with some embodiments. Example implementations, in accordance with various embodiments, of the UE (such as a UE 112a of FIG. 2 and/or UE 200 of FIG. 2), network node (such as network node 110a of FIG. 2 and/or network node 300 of FIG. 3), and host (such as host 116 of FIG. 2 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the data rate and latency and thereby provide benefits such as reduced user waiting time, better responsiveness, and better QoE.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc, from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes: the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.: the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

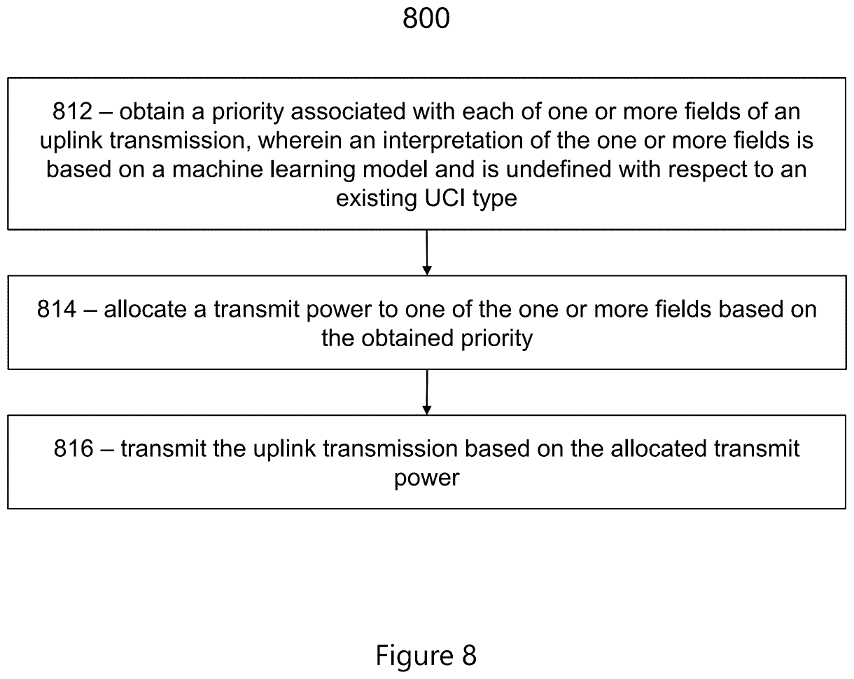

FIG. 8 is a flowchart illustrating an example method in a wireless device. according to certain embodiments. In particular embodiments, one or more steps of FIG. 8 may be performed by UE 200 described with respect to FIG. 3.

The method begins at step 812, where the wireless device (e.g., UE 200) obtains a priority associated with each of one or more fields of an uplink transmission. An interpretation of the one or more fields is based on a machine learning model and is undefined with respect to an existing UCI type (e.g., hybrid automatic repeat request (HARQ) acknowledgement (ACK), scheduling request (SR), channel state information (CSI), etc.).

For example, existing UCI types are defined in a standard where the priorities between them are also defined. The one or more fields that are based on a machine learning model (e.g., output of a model, parameters associated with a model, etc.) are not defined in the standard and thus the wireless device obtains a priority associated with each of one or more fields with respect to each other and/or with respect to existing UCI types. Examples of prioritization are described in more detail above.

In particular embodiments, the one or more fields comprise one or more of an output of the machine learning model, one or more machine learning model parameters associated with the machine learning model, or an existing UCI type generated by the machine learning model (e.g., Scenarios 1, 2 and 3 described above).

In particular embodiments, the priority associated with each of the one or more fields is in relation to a priority associated with one or more existing UCI types and allocating the transmit power for the one of the one or more fields is based on the priority associated with existing UCI type and the obtained priority.

In particular embodiments, a priority associated with one of the one or more fields comprises a priority higher, equal to, or lower than a priority associated with one or more existing UCI types.

In particular embodiments, obtaining the priority associated with each of one or more fields of an uplink transmission comprises one or more of obtaining pre-defined priority rules and receiving priority rules from a network node.

In particular embodiments, the one of the one or more fields comprises a CSI report generated by a machine learning model. In particular embodiments, the one of the one or more fields comprises a machine learning model identifier. In particular embodiments, the one of the one or more fields comprise any of the fields described with respect to the embodiments and examples described herein.

At step 814, the wireless device allocates a transmit power to one of the one or more fields based on the obtained priority. Examples are described in more detail above.

At step 816, the wireless device transmits the uplink transmission based on the allocated transmit power.

Modifications, additions, or omissions may be made to method 800 of FIG. 8. Additionally, one or more steps in the method of FIG. 8 may be performed in parallel or in any suitable order.

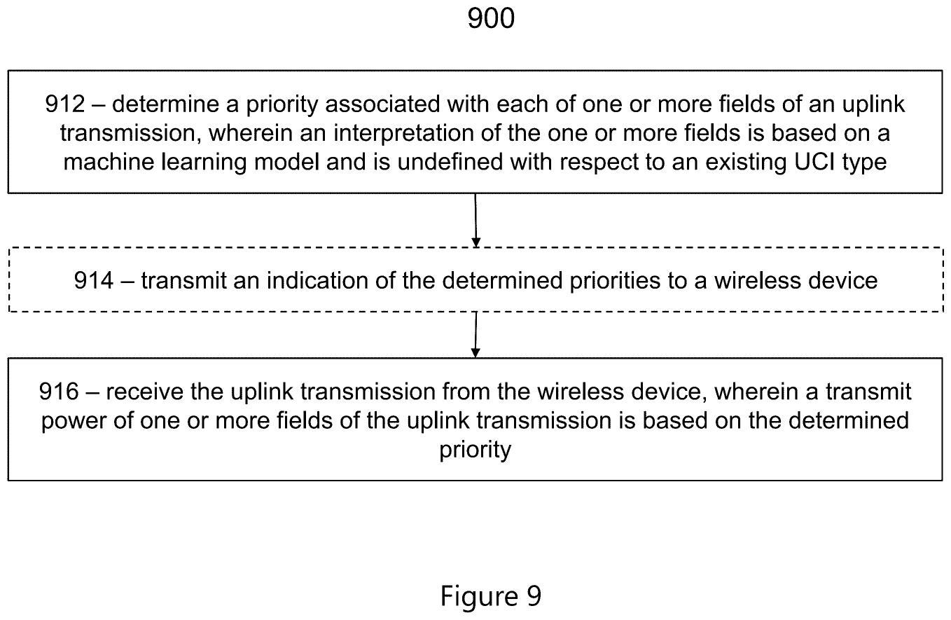

FIG. 9 is a flowchart illustrating an example method in a network node, according to certain embodiments. In particular embodiments, one or more steps of FIG. 9 may be performed by network node 300 described with respect to FIG. 4.

The method begins at step 912, where the network node (e.g., network node 300) determines a priority associated with each of one or more fields of an uplink transmission. An interpretation of the one or more fields is based on a machine learning model and is undefined with respect to an existing UCI type.

In particular embodiments, the one or more fields comprise one or more of an output of the machine learning model, one or more machine learning model parameters associated with the machine learning model, or an existing UCI type generated by the machine learning model.

In particular embodiments, the priority associated with each of the one or more fields is in relation to a priority associated with one or more existing UCI types and the transmit power for the one of the one or more fields is allocated based on a transmit power priority associated with existing UCI type and the determined priority

In particular embodiments, a priority associated with one of the one or more fields comprises a priority higher, equal to, or lower than a priority associated with one or more existing UCI types.

In particular embodiments, determining the priority associated with each of one or more fields of an uplink transmission comprises one or more of obtaining pre-defined priority rules and training a machine learning model.

In particular embodiments, the one of the one or more fields comprises a CSI report generated by a machine learning model. In particular embodiments, the one of the one or more fields comprises a machine learning model identifier. In particular embodiments, the one of the one or more fields comprise any of the fields described with respect to the embodiments and examples described herein.

At step 914, the network node may transmit an indication of the determined priorities to the wireless device. This step is optional because in some embodiments the wireless device may obtain the priorities on its own or from another network node.

At step 916, the network node receives the uplink transmission from the wireless device, wherein a transmit power of one or more fields of the uplink transmission is based on the determined priority.

Modifications, additions, or omissions may be made to method 900 of FIG. 9. Additionally, one or more steps in the method of FIG. 9 may be performed in parallel or in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device, the method comprising:
   determining a priority associated with an uplink transmission wherein the contents of the uplink transmission are based on a machine learning model where the format of the contents are unknown to the wireless device;
   allocating a transmit power to the uplink transmission based on the priority; and
   transmitting the uplink transmission based on the allocated transmit power.
2. The method of the previous embodiment, wherein the priority is determined based on any of the embodiments and examples described above.
3. A method performed by a wireless device, the method comprising:
   any of the wireless device steps, features, or functions described above, either alone or in combination with other steps, features, or functions described above.
4. The method of the previous embodiment, further comprising one or more additional wireless device steps, features or functions described above.
5. The method of any of the previous embodiments, further comprising:
   providing user data; and
   forwarding the user data to a host computer via the transmission to the base station.

### Group B Embodiments

6. A method performed by a base station, the method comprising:
   determining a priority associated with an uplink transmission wherein the contents of the uplink transmission are based on a machine learning model where the format of the contents are unknown to a wireless device; and
   transmitting an indication of the determined priority to the wireless device.
7. The method of the previous embodiment, wherein the priority is determined based on any of the embodiments and examples described above.
8. A method performed by a base station, the method comprising:
   any of the steps, features, or functions described above with respect to base station, either alone or in combination with other steps, features, or functions described above.
9. The method of the previous embodiment, further comprising one or more additional base station steps, features or functions described above.
10. The method of any of the previous embodiments, further comprising:
   obtaining user data; and
   forwarding the user data to a host computer or a wireless device.

### Group C Embodiments

11. A mobile terminal comprising:
   processing circuitry configured to perform any of the steps of any of the Group A embodiments; and
   power supply circuitry configured to supply power to the wireless device.
12. A base station comprising:
   processing circuitry configured to perform any of the steps of any of the Group B embodiments
   power supply circuitry configured to supply power to the wireless device.
13. A user equipment (UE) comprising:
   an antenna configured to send and receive wireless signals;
   radio front-end circuitry connected to the antenna and to processing circuitry, and configured to condition signals communicated between the antenna and the processing circuitry:
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
14. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
15. The communication system of the pervious embodiment further including the base station.
16. The communication system of the previous 2 embodiments, further including the UE, wherein the UE is configured to communicate with the base station.
17. The communication system of the previous 3 embodiments, wherein:
   the processing circuitry of the host computer is configured to execute a host application, thereby providing the user data; and
   the UE comprises processing circuitry configured to execute a client application associated with the host application.
18. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
19. The method of the previous embodiment, further comprising, at the base station, transmitting the user data.
20. The method of the previous 2 embodiments, wherein the user data is provided at the host computer by executing a host application, the method further comprising, at the UE, executing a client application associated with the host application.
21. A user equipment (UE) configured to communicate with a base station, the UE comprising a radio interface and processing circuitry configured to performs any of the previous 3 embodiments.
22. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
23. The communication system of the previous embodiment, wherein the cellular network further includes a base station configured to communicate with the UE.
24. The communication system of the previous 2 embodiments, wherein:
   the processing circuitry of the host computer is configured to execute a host application, thereby providing the user data; and
   the UE's processing circuitry is configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
26. The method of the previous embodiment, further comprising at the UE, receiving the user data from the base station.
27. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
28. The communication system of the previous embodiment, further including the UE.
29. The communication system of the previous 2 embodiments, further including the base station, wherein the base station comprises a radio interface configured to communicate with the UE and a communication interface configured to forward to the host computer the user data carried by a transmission from the UE to the base station.
30. The communication system of the previous 3 embodiments, wherein:
   the processing circuitry of the host computer is configured to execute a host application; and
   the UE's processing circuitry is configured to execute a client application associated with the host application, thereby providing the user data.
31. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
32. A method implemented in a communication system including a host computer, a base station and a user equipment (UE), the method comprising:
   at the host computer, receiving user data transmitted to the base station from the UE, wherein the UE performs any of the steps of any of the Group A embodiments.
33. The method of the previous embodiment, further comprising, at the UE, providing the user data to the base station.
34. The method of the previous 2 embodiments, further comprising:
   at the UE, executing a client application, thereby providing the user data to be transmitted; and
   at the host computer, executing a host application associated with the client application.
35. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
36. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
37. The communication system of the previous embodiment further including the base station.
38. The communication system of the previous 2 embodiments, further including the UE, wherein the UE is configured to communicate with the base station.
39. The communication system of the previous 3 embodiments, wherein:
   the processing circuitry of the host computer is configured to execute a host application;
   the UE is configured to execute a client application associated with the host application, thereby providing the user data to be received by the host computer.
40. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
41. The method of the previous embodiment, further comprising at the base station, receiving the user data from the UE.
42. The method of the previous 2 embodiments, further comprising at the base station, initiating a transmission of the received user data to the host computer.

1. A method performed by wireless device, the method comprising:
obtaining a priority associated with each of one or more fields of an uplink transmission, wherein an interpretation of the one or more fields is based on a machine learning model and is undefined with respect to an existing uplink control information, UCI, type:
allocating a transmit power to one of the one or more fields based on the obtained priority; and
transmitting the uplink transmission based on the allocated transmit power.

2. The method of claim 1, wherein the one or more fields comprise one or more of an output of the machine learning model, one or more machine learning model parameters associated with the machine learning model, or an existing UCI type generated by the machine learning model.

3. The method of claim 1, wherein the priority associated with each of the one or more fields is in relation to a priority associated with one or more existing UCI types and allocating the transmit power for the one of the one or more fields is based on the priority associated with existing UCI type and the obtained priority.

4. The method of claim 3, wherein a priority associated with one of the one or more fields comprises a priority higher than a priority associated with one or more existing UCI types.

5. The method of claim 3, wherein a priority associated with one of the one or more fields comprises a priority lower than a priority associated with one or more existing UCI types.

6. The method of claim 1, wherein obtaining the priority associated with each of one or more fields of an uplink transmission comprises one or more of:
obtaining pre-defined priority rules; and
receiving priority rules from a network node.

7.-8. (canceled)

9. A wireless device comprising processing circuitry operable to:
obtain a priority associated with each of one or more fields of an uplink transmission, wherein an interpretation of the one or more fields is based on a machine learning model and is undefined with respect to an existing uplink control information, UCI, type;
allocate a transmit power to one of the one or more fields based on the obtained priority; and
transmit the uplink transmission based on the allocated transmit power.

10.-16. (canceled)

17. A method performed by a network node, the method comprising:
determining a priority associated with each of one or more fields of an uplink transmission, wherein an interpretation of the one or more fields is based on a machine learning model and is undefined with respect to an existing uplink control information, UCI, type; and
receiving the uplink transmission from a wireless device, wherein a transmit power of one or more fields of the uplink transmission is based on the determined priority.

18. The method of claim 17, further comprising transmitting an indication of the determined priorities to the wireless device.

19. The method of claim 17, wherein the one or more fields comprise one or more of an output of the machine learning model, one or more machine learning model parameters associated with the machine learning model, or an existing UCI type generated by the machine learning model.

20. The method of claim 17, wherein the priority associated with each of the one or more fields is in relation to a priority associated with one or more existing UCI types and the transmit power for the one of the one or more fields is allocated based on a transmit power priority associated with existing UCI type and the determined priority

21. The method of claim 20 wherein a priority associated with one of the one or more fields comprises a priority higher than a priority associated with one or more existing UCI types.

22. The method of claim 20, wherein a priority associated with one of the one or more fields comprises a priority lower than a priority associated with one or more existing UCI types.

23. The method of claim 17, wherein determining the priority associated with each of one or more fields of an uplink transmission comprises one or more of:
obtaining pre-defined priority rules; and
training a machine learning model.

24.-25. (canceled)

26. A network node comprising processing circuitry, the processing circuitry operable to:
determine a priority associated with each of one or more fields of an uplink transmission, wherein an interpretation of the one or more fields is based on a machine learning model and is undefined with respect to an existing uplink control information, UCI, type; and
receive the uplink transmission from a wireless device, wherein a transmit power of one or more fields of the uplink transmission is based on the determined priority.

27. (canceled)
